(19) United States
(12) Patent Application Publication
(10) Pub. No.: US 2025/0231759 A1
(43) Pub. Date: Jul. 17, 2025

(54) IN-VEHICLE APPARATUS, COMPUTER PROGRAM, AND PROGRAM UPDATING METHOD

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventors: Ken FURUTO, Yokkaichi-Shi, Mie (JP); Hiroshi TATEISHI, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/852,953

(22) PCT Filed: Apr. 4, 2023
(86) PCT No.: PCT/JP2023/013877

§ 371 Date: Sep. 30, 2024

(30) Foreign Application Priority Data
Apr. 4, 2022 (JP) 2022-062541

(51) Int. Cl. G06F 8/65; G06F 11/07

(52) U.S. Cl. CPC G06F 8/65; G06F 11/0751

(57) ABSTRACT

An in-vehicle apparatus is connected to a first bus that is connected to a first gateway that relays communication between buses, acquires an update program from outside a vehicle, and updates a program of the first gateway and an in-vehicle ECU. The in-vehicle apparatus includes a control unit configured to update the first gateway with priority, when upgrade targets include the first gateway and an in-vehicle ECU on a second bus connected to the first gateway.

### CROSS-REFERENCE TO RELATED APPLICATIONS

This application is the U.S. national stage of PCT/JP2023/013877 filed on Apr. 4, 2023, which claims priority of Japanese Patent Application No. JP 2022-062541 filed on Apr. 4, 2022, the contents of which are incorporated herein.

### TECHNICAL FIELD

The present disclosure relates to an in-vehicle apparatus, a computer program, and a program updating method.

### BACKGROUND

A vehicle is equipped with ECUs (Electronic Control Units) for controlling in-vehicle devices, which may relate to driving control, as in the case of engine control, or the vehicle body, as in the case of air conditioner control. An ECU includes an arithmetic processing unit such as an MPU, a rewritable non-volatile storage unit such as an EEPROM, and a communication unit for communicating with other ECUs, and controls one or more in-vehicle devices by reading and executing a control program stored in the storage unit. A vehicle is also equipped with a communication device with a wireless communication function, and can communicate, via this communication device, with a program providing apparatus connected to a network outside the vehicle, download (receive) a control program for an ECU from this program providing apparatus, and update the control program for the ECU in question (see, for example, JP 2017-97851A).

It is assumed that two buses are connected to a relay apparatus, and that the relay apparatus and apparatuses connected to the two buses are included in the update targets of a control program. For this configuration, if an abnormality occurs, such as the updating of the relay apparatus not being performed correctly, there is the risk that communication between the two buses may not be possible after the update.

However, the communication device in JP 2017-97851A does not consider this type of problem described above and does not provide a solution.

For this reason, it is an object of the present disclosure to provide an in-vehicle apparatus, a computer program, and a program updating method that can prevent a situation where communication between buses connected by a relay apparatus is no longer possible after a program updating process.

### SUMMARY

An in-vehicle apparatus according to an aspect of the present disclosure is connected to a first bus connected to a relay apparatus that relays communication between buses, acquires an update program from outside a vehicle, and updates a program of the relay apparatus and an in-vehicle ECU, the in-vehicle apparatus including a control unit configured to update the relay apparatus with priority, when update targets include the relay apparatus and an in-vehicle ECU on a second bus connected to the relay apparatus.

A computer program according to an aspect of the present disclosure causes an in-vehicle computer, which is connected to a first bus connected to a relay apparatus that relays communication between buses, acquires an update program from outside a vehicle, and updates a program of the relay apparatus and an in-vehicle ECU, to execute a process including updating the relay apparatus with priority, when update targets include the relay apparatus and an in-vehicle ECU on a second bus connected to the relay apparatus.

A program updating method according to the present disclosure causes an in-vehicle apparatus, which is connected to a first bus connected to a relay apparatus that relays communication between buses, acquires an update program from outside a vehicle, and updates a program of the relay apparatus and an in-vehicle ECU, to execute a process including updating the relay apparatus with priority, when update targets include the relay apparatus and an in-vehicle ECU on a second bus connected to the relay apparatus.

### Advantageous Effects

According to the present disclosure, it is possible to prevent a situation where communication between buses connected by a relay apparatus is no longer possible after a program updating process.

### BRIEF DESCRIPTION OF DRAWINGS

FIG. 1 is a schematic diagram depicting the configuration of an in-vehicle updating system according to a first embodiment.

FIG. 2 is a block diagram depicting the configuration of an in-vehicle apparatus.

FIG. 3 is a diagram useful in explaining one example of a processing flow (or “sequence”) of an in-vehicle apparatus, devices that are the update targets (a first gateway and in-vehicle ECUs), and the like.

FIGS. 4A-4C are diagrams useful in explaining state transitions of the in-vehicle apparatus, the first gateway, and the in-vehicle ECUs that are the update targets during a program updating process.

FIGS. 5A and 5B are diagrams useful in explaining state transitions of the in-vehicle apparatus, the first gateway, and the in-vehicle ECUs that are the update targets during a rollback process.

FIG. 6 is a flowchart illustrating one example of the processing of the control unit of an in-vehicle apparatus.

FIG. 7 is a diagram useful in explaining another example of a processing flow (or “sequence”) of the in-vehicle apparatus, the devices that are the update targets (the first gateway and in-vehicle ECUs), and the like.

FIGS. 8A and 8B are diagrams useful in explaining state transitions of the in-vehicle apparatus, the first gateway, and the in-vehicle ECUs that are the update targets during a program updating process.

FIGS. 9A-9C are diagrams useful in explaining state transitions of the in-vehicle apparatus, the first gateway, and in-vehicle ECUs that are the update targets during a rollback process.

FIG. 10 is a flowchart illustrating another example of the processing of the control unit of an in-vehicle apparatus.

FIGS. 11A-11D are diagrams useful in explaining state transitions at each apparatus during an updating process for a program according to a first modification.

FIGS. 12A-12D are diagrams useful in explaining state transitions at each apparatus during a rollback process according to the first modification.

FIGS. 13A-13D are diagrams illustrating a configuration in which an in-vehicle updating system according to a second modification includes a virtual network.

### DETAILED DESCRIPTION OF PREFERRED EMBODIMENTS

Several embodiments of the present disclosure will first be listed and described in outline. Note that the embodiments described below may also be freely combined, at least in part.

An in-vehicle apparatus according to an aspect of the present disclosure is connected to a first bus connected to a relay apparatus that relays communication between buses, acquires an update program from outside a vehicle, and updates a program of the relay apparatus and an in-vehicle ECU, the in-vehicle apparatus including a control unit configured to update the relay apparatus with priority, when update targets include the relay apparatus and an in-vehicle ECU on a second bus connected to the relay apparatus.

In the present embodiment, when the update targets include the relay apparatus and an in-vehicle ECU on the second bus, the control unit updates the relay apparatus with priority and continues the updating process after ensuring that the relay apparatus is in a normal state. Accordingly, updating of a program at the in-vehicle ECU on the second bus can be performed correctly.

In the in-vehicle apparatus according to an aspect of the present disclosure, when the update targets include the relay apparatus, the in-vehicle ECU on the second bus, and the in-vehicle ECU on the first bus, the control unit updates the relay apparatus and the in-vehicle ECU on the first bus with priority.

In the present embodiment, when the update targets include an in-vehicle ECU on the first bus in addition to the relay apparatus and an in-vehicle ECU on the second bus, the control unit updates the relay apparatus and the in-vehicle ECU on the first bus with priority and continues the updating process after ensuring that the relay apparatus is in a normal state. Accordingly, updating of a program at an in-vehicle ECU on the second bus can be performed correctly.

The in-vehicle apparatus according to an aspect of the present disclosure further includes an abnormality detection unit configured to detect an abnormality at the relay apparatus after an activation process, which applies the update program to the relay apparatus, has been executed.

In the present embodiment, after the activation process has been executed at the relay apparatus, the abnormality detection unit performs abnormality detection at the relay apparatus and confirms that the relay apparatus is normal. In this way, since the processing continues after ensuring that the relay apparatus is in a normal state, the updating of a program can be performed correctly for the in-vehicle ECU on the second bus.

In the in-vehicle apparatus according to the present disclosure, when an abnormality has not been detected, the control unit updates the in-vehicle ECU on the second bus.

In the present embodiment, after the activation process is executed at the relay apparatus, the abnormality detection unit performs abnormality detection at the relay apparatus and continues the updating at the in-vehicle ECU on the second bus after confirming that no abnormality has been detected. In this way, since it is ensured that the relay apparatus is in the normal state before execution, the updating of a program at the in-vehicle ECU on the second bus can be executed correctly.

In the in-vehicle apparatus according to the present disclosure, when the update targets further include another relay apparatus, which is connected to the second bus, and an in-vehicle ECU on a third bus connected to the other relay apparatus, the control unit updates the in-vehicle ECU on the second bus and the other relay apparatus together and performs an updating process for the in-vehicle ECU on the third bus after updating the other relay apparatus.

In the present embodiment, when the update targets include the relay apparatus, the in-vehicle ECU on the first bus, the in-vehicle ECU on the second bus, the other relay apparatus, and the in-vehicle ECU on the third bus, the control unit updates the in-vehicle ECU on the second bus and the other relay apparatus together and ensures that the other relay apparatus is in the normal state, before continuing with the updating process for the in-vehicle ECU on the third bus. Accordingly, updating of a program at an in-vehicle ECU on the third bus can be performed correctly.

In the in-vehicle apparatus according to the present disclosure, when an abnormality has been detected, the control unit executes a rollback process, which restores a program after updating to a program before updating, at the relay apparatus and the in-vehicle ECU on the first bus with priority.

With the present embodiment, if an abnormality has been detected after an update, the control unit executes a rollback process at the relay apparatus and the in-vehicle ECU on the first bus with priority. By doing so, the rollback process continues after ensuring that the relay apparatus is in a normal state in the execution environment of the original program. In this way, since the rollback process is executed after ensuring that the relay apparatus is in a normal state, the rollback process can be executed correctly at the in-vehicle ECU on the second bus.

In the in-vehicle apparatus according to the present disclosure, the control unit executes the rollback process at the in-vehicle ECU on the second bus after executing the rollback process on the relay apparatus.

In the present embodiment, the control unit executes the rollback process on the relay apparatus, and after ensuring that the relay apparatus is in the normal state in the execution environment of the original program, executes rollback process on the in-vehicle ECU on the second bus. In this way, since the normal state of the relay apparatus is ensured before execution, the rollback process can be correctly executed at the in-vehicle ECU on the second bus.

In the in-vehicle apparatus according to the present disclosure, when updating has also been performed at another relay apparatus connected to a second bus and an in-vehicle ECU on a third bus connected to the other relay apparatus, the control unit performs a rollback process at the ECU on the second bus and the other relay apparatus together, and performs a rollback process on the in-vehicle ECU on the third bus after the rollback process on the other relay apparatus.

In the present embodiment, when the other relay apparatus and an in-vehicle ECU on the third bus have been updated in addition to the relay apparatus, the in-vehicle ECU on the first bus, and the in-vehicle ECU on the second bus, the control unit performs the rollback process on the in-vehicle ECU on the second bus and the other relay apparatus together, ensures that the other relay apparatus is in the normal state, and then continues the rollback process on the in-vehicle ECU on the third bus. Accordingly, the rollback process for the in-vehicle ECU on the third bus can be performed correctly.

A computer program according to an aspect of the present disclosure causes an in-vehicle computer, which is connected to a first bus connected to a relay apparatus that relays communication between buses, acquires an update program from outside a vehicle, and updates a program of the relay apparatus and an in-vehicle ECU, to execute a process including updating the relay apparatus with priority, when update targets include the relay apparatus and an in-vehicle ECU on a second bus connected to the relay apparatus.

With the present embodiment, when the update targets include the relay apparatus and the in-vehicle ECU on the second bus, the computer of the in-vehicle apparatus updates the relay apparatus with priority and continues the updating process after ensuring that the relay apparatus is in a normal state. Accordingly, updating of a program at the in-vehicle ECU on the second bus can be performed correctly.

A program updating method according to an embodiment of the present disclosure causes an in-vehicle apparatus, which is connected to a first bus connected to a relay apparatus that relays communication between buses, acquires an update program from outside a vehicle, and updates a program of the relay apparatus and an in-vehicle ECU, to execute a process including updating the relay apparatus with priority, when update targets include the relay apparatus and an in-vehicle ECU on a second bus connected to the relay apparatus.

In the present embodiment, when the update targets include the relay apparatus and the in-vehicle ECU on the second bus, the in-vehicle apparatus updates the relay apparatus with priority and continues the updating process after ensuring that the relay apparatus is in a normal state. Accordingly, updating of a program at the in-vehicle ECU on the second bus can be performed correctly.

An in-vehicle apparatus, a computer program, and a program updating method according to specific embodiments of the present disclosure will now be described in detail with reference to the attached drawings. Note that the present disclosure is not limited to the illustrated examples and is instead indicated by the range of the patent claims and intended to include all possible changes within the meaning and scope of the patent claims and their equivalents.

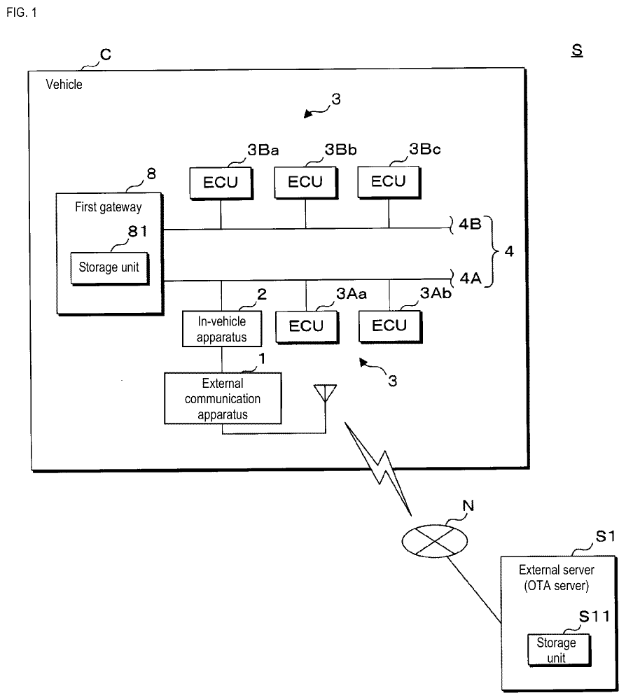

Several embodiments will be described below with reference to the attached drawings. FIG. 1 is a schematic diagram depicting the configuration of an in-vehicle updating system S according to a first embodiment. The in-vehicle updating system S includes an external communication apparatus 1 and an in-vehicle apparatus 2 that are mounted in a vehicle C, and transmits an update program acquired from an external server S1 (or “OTA server”) connected via an external network N to an in-vehicle ECUs 3 (Electronic Control Units) mounted in the vehicle C.

The external server S1 is a computer, such as a server, connected to the external network N, which for example is the Internet or a public telephone network, and includes a storage unit S11, such as a RAM (Random Access Memory), a ROM (Read Only Memory), or a hard disk drive. The storage unit S11 of the external server S1 stores a program or data which is used to control an in-vehicle ECU 3 and has been created by the manufacturer or the like of the in-vehicle ECU 3. This program or data is transmitted as described later to the vehicle C as an update program, and is used to update the program or data of an in-vehicle ECU 3 mounted in the vehicle C. The external server S1 configured in this way is also referred to as an “OTA (Over The Air) server”.

The in-vehicle apparatus 2 functions as a so-called “OTA master” that transmits an update program, which has been acquired from the external server S1 via the external communication apparatus 1, to the in-vehicle ECU 3 which is to be updated (hereinafter referred to as the “update target”), and also transmits an activation instruction so that the transmitted update program is applied to the in-vehicle ECU 3 in question.

The in-vehicle ECU 3 mounted in the vehicle C acquires the update program transmitted by wireless communication from the external server S1 via the in-vehicle apparatus 2, and updates (reprograms) the program to be executed by this ECU 3 by applying the update program in response to an activation instruction from the in-vehicle apparatus 2 (this is referred to as an “activation process”).

As one example, the program includes program code including control syntax and the like used by the in-vehicle ECU 3 to perform processing, and an external file containing data that is referenced when the program code is executed. When the update program is transmitted, an external file in which program code and data are written is transmitted from the external server S1 as an encrypted archive file, for example. When transmitting the update program, the external server S1 generates a package including the update program and transmits the generated package to the vehicle C. As one example, the package includes package information (or “campaign information”), which is information relating to the program update, information (or “target information”) indicating the update target, and the update program to be applied to the update target.

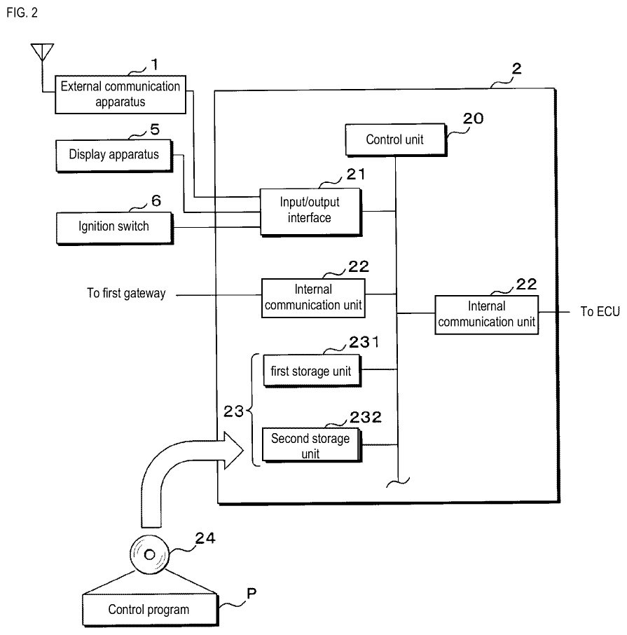

The vehicle C is equipped with the external communication apparatus 1, the in-vehicle apparatus 2, and a first gateway 8. A plurality of buses 4 are connected to the first gateway 8, and a plurality of in-vehicle ECUs 3 for controlling various in-vehicle devices are connected to these buses 4. The vehicle C is also equipped with a display apparatus 5 (see FIG. 2) and an ignition switch 6 (see FIG. 2).

The following describes an example in which two buses 4A and 4B are connected to the first gateway 8, the in-vehicle ECUs 3Aa and 3Ab are connected to the bus 4A, and the in-vehicle ECUs 3Ba, 3Bb, and 3Bc are connected to the bus 4B. The present disclosure is not limited to this configuration, so there may be three or more buses 4 and four or more in-vehicle ECUs 3 may be connected to each bus 4.

The external communication apparatus 1 and the in-vehicle apparatus 2 are connected by and capable of communication via a harness, such as a serial cable. The first gateway 8 selectively relays communication data between the bus 4A and the bus 4B and can convert the communication protocol between the bus 4A and the bus 4B during such relaying. The first gateway 8, the in-vehicle apparatus 2, and the in-vehicle ECU 3 are connected and capable of communication via a bus 4 that is compatible with a communication protocol such as CAN (Control Area Network), CAN-FD (CAN with Flexible Data Rate), or Ethernet (registered trademark).

The external communication apparatus 1 includes an external communication unit (not illustrated) and an input/output interface (also not illustrated) for communicating with the in-vehicle apparatus 2. The external communication unit is a communication apparatus for wireless communication using a mobile communication protocol, such as LTE (registered trademark), 4G, 5G, or WiFi (registered trademark), and transmits and receives data to and from the external server S1 via an antenna connected to the external communication unit. This communication between the external communication apparatus 1 and the external server S1 is performed via the external network N, such as a public telephone network or the Internet.

The input/output interface of the external communication apparatus 1 is a communication interface for communicating, for example via serial communication, with the in-vehicle apparatus 2. The external communication apparatus 1 and the in-vehicle apparatus 2 communicate with each other via a harness, such as a serial cable. Although the external communication apparatus 1 is a separate device from the in-vehicle apparatus 2 in the present embodiment, with these devices being connected by and communicating via an input/output interface or the like, the present disclosure is not limited to this. The external communication apparatus 1 may be incorporated into the in-vehicle apparatus 2 as one component of the in-vehicle apparatus 2. Alternatively, the external communication apparatus 1 and the in-vehicle apparatus 2 may be connected by a bus, such as a CAN bus.

The first gateway 8 is an in-vehicle relay apparatus that is in overall control of the plurality of buses 4 (segments) for different systems, such as in-vehicle ECUs 3 relating to control systems, in-vehicle ECUs 3 relating to safety systems, and in-vehicle ECUs 3 relating to the vehicle body, and relays communication between in-vehicle ECUs 3 on different buses (segments). The first gateway 8 functions as a CAN gateway when relaying according to CAN protocol, and functions as a layer 2 switch or a layer 3 switch when relaying according to TCP/IP protocol. The first gateway 8 may be a PLB (Power Lan Box) which, in addition to relaying communication, functions as a power distribution apparatus that distributes and relays power, which is outputted from a power supply apparatus such as a secondary battery, so as to supply power to in-vehicle devices, such as actuators, connected to the first gateway 8.

The first gateway 8 includes a storage unit 81. The storage unit 81 stores information relating to the respective versions of two programs, that is, a current version and an old version, and information relating to an area (or “active side”) in which the program currently being executed (used) is stored. That is, when a program (or “control program”) stored in a first area is currently being executed, the storage unit 81 stores information indicating that the active side is the first area. In this case, information indicating that the inactive side is a second area is stored. The current version of the control program is stored in the first area, which is the active side. The second area, which is the inactive area, stores the old version of the control program. Alternatively, the second area, which is the inactive side, may be a storage area that does not store the old version of the control program or the like and may be free space. In this way, the inactive side is a storage area that is free space or a storage area storing an old version of the control program or the like, so that by writing a new version of the control program into this inactive side during an update, it is possible to ensure that the old version can be restored.

FIG. 2 is a block diagram depicting the configuration of the in-vehicle apparatus 2.

The in-vehicle apparatus 2 includes a control unit 20, a storage unit 23, an input/output interface 21, and an internal communication unit 22. The in-vehicle apparatus 2 is configured to acquire, from the external communication apparatus 1, an update program (or “package) that the external communication apparatus 1 has received via wireless communication from the external server S1, and to transmit the update program via the buses 4 to devices that are the update targets. In other words, the in-vehicle apparatus 2 functions as an OTA master (or “update control apparatus”) that controls program updates at devices that are the update targets.

The in-vehicle apparatus 2 may be configured as one functional part of a body ECU that controls the vehicle C as a whole. Alternatively, the in-vehicle apparatus 2 may be an integrated ECU that is constructed at a central control apparatus, such as a vehicle computer, and performs overall control of the vehicle C.

The control unit 20 is composed of a CPU (Central Processing Unit), an MPU (Micro Processing Unit), or the like and is configured to perform various control processing, computational processing, and the like by reading and executing a control program P and data stored in advance in the storage unit 23.

The storage unit 23 is composed of two storage areas, a first storage unit 231 and a second storage unit 232, and each of the first storage unit 231 and the second storage unit 232 is composed of a volatile memory element, such as a RAM (Random Access Memory), or a nonvolatile memory element, such as a ROM (Read Only Memory), an EEPROM (Electrically Erasable Programmable ROM) or a flash memory. The control program P and data to be referenced during processing are stored in advance in the first storage unit 231 and the second storage unit 232. The control program P stored in the storage unit 23 (the first storage unit 231 or the second storage unit 232) may be a control program P that was read from a recording medium 24 which is readable by the in-vehicle apparatus 2. The control program P may also be a program that was downloaded from an external computer (not illustrated) that is connected to a communication network (not illustrated) and then stored in the storage unit 23.

The input/output interface 21 is a communication interface for serial communication for example, in the same way as the input/output interface of the external communication apparatus 1 described above. The in-vehicle apparatus 2 is connected to and capable of communicating with the external communication apparatus 1, the display apparatus 5, and the ignition switch 6 via this input/output interface 21. An ignition signal may also be acquired via an in-vehicle LAN.

The internal communication unit 22 is an input/output interface that uses a communication protocol such as CAN or Ethernet (registered trademark). The control unit 20 communicates via the internal communication unit 22 with in-vehicle devices, such as the in-vehicle ECUs 3 on the bus 4A or the first gateway 8, and also communicates via the first gateway 8 with the in-vehicle ECUs 3 on the bus 4B. A plurality of internal communication units 22 (in the present embodiment, two) are provided.

The in-vehicle apparatus 2 executes processing relating to the application of an update program to the in-vehicle ECUs 3 and the first gateway 8. As will be described in detail later, the in-vehicle apparatus 2 transmits the update program to in-vehicle ECUs 3 and the first gateway 8, issues activation instructions, checks for abnormalities following an activation process, and issues a rollback instruction when an abnormality has been detected.

The in-vehicle apparatus 2 generates and stores update information used for an abnormality check to be performed after activation, based on the update program from the external server S1. The update information is stored in association with at least the ID of each in-vehicle ECU 3, the current program version, and the update program version.

In more detail, the in-vehicle apparatus 2 communicates with every in-vehicle ECU 3 and the first gateway 8 installed in the vehicle C (or “host vehicle”) on a regular, cyclical, or routine basis, and acquires the version information of programs relating to every in-vehicle ECU 3 and the first gateway 8. The in-vehicle apparatus 2 stores the transmitted program version information in association with each of these devices. Alternatively, it is possible to use a configuration where each in-vehicle ECU 3 and the first gateway 8 periodically or cyclically transmits the current program version to the in-vehicle apparatus 2 without the in-vehicle apparatus 2 requesting that each in-vehicle ECU 3 and the first gateway 8 transmit the current program version.

When the in-vehicle apparatus 2 has acquired the package from the external server S1, the version of the update program for each device that is an update target is acquired based on the campaign information, the target information, and the update program. Alternatively, a configuration may be used where a device that is an update target transmits the version of an update program that has been applied to the device to the in-vehicle apparatus 2 every time activation of an update program is completed.

The in-vehicle apparatus 2 generates the update information by aggregating the current program version acquired from each in-vehicle ECU 3 and the first gateway 8 and the version of the update program and stores the generated update information in the storage unit 23. The update information may be stored in the first storage unit 231 or the second storage unit 232, or may be stored with redundancy in both the first storage unit 231 and the second storage unit 232.

In the same way as the in-vehicle apparatus 2, each in-vehicle ECU 3 includes a control unit, a storage unit, and an internal communication unit (none of which are illustrated). The storage unit is composed of a volatile memory element such as a RAM (Random Access Memory), or a nonvolatile memory element such as a ROM (Read Only Memory), an EEPROM (Electrically Erasable Programmable ROM) or flash memory, and stores a program or data for the in-vehicle ECU 3. This program or data are to be updated by the update program that is transmitted from the external server S1 and relayed by the in-vehicle apparatus 2 (or the first gateway 8). Like the in-vehicle apparatus 2, the internal communication unit of the in-vehicle ECU 3 is composed of a CAN transceiver or an Ethernet PHY unit, for example, and communicates with the in-vehicle apparatus 2.

In the same way as the storage unit 81 of the first gateway 8, the storage unit of each in-vehicle ECU 3 is provided with a first area and a second area. When a program (or “control program”) stored in the first area is currently being executed, information indicating that the active side is the first area is stored, and information indicating that the inactive side is the second area is stored. The current version of the control program is stored in the first area, which is the active side. The second area, which is the inactive side, stores an old version of the control program. Alternatively, the second area, which is the inactive side, may be a storage area that does not store an old version of the control program or the like and may be free space.

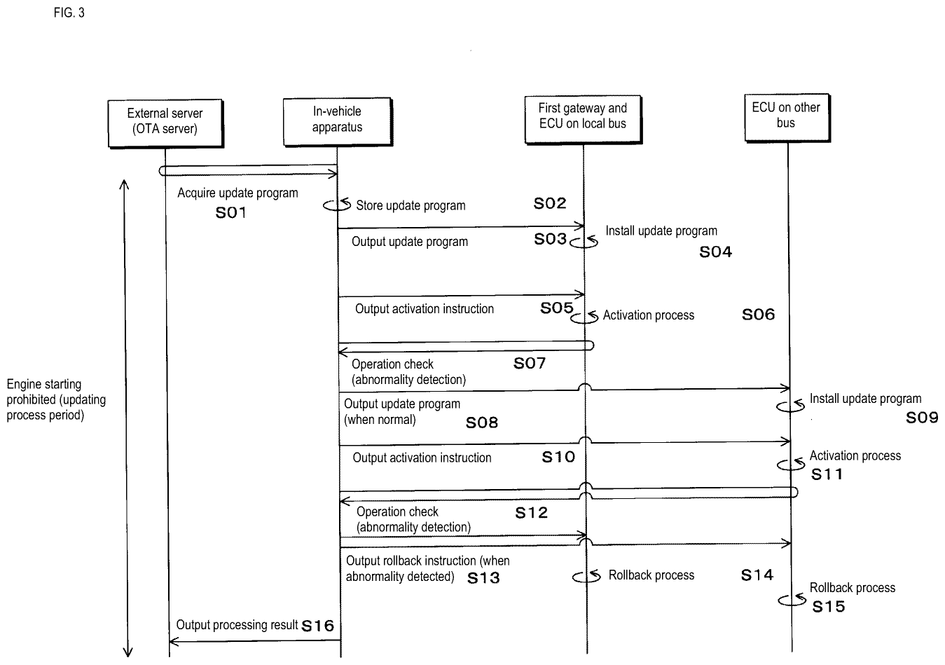

FIG. 3 is a diagram useful in explaining one example of a processing flow (or “sequence”) of the in-vehicle apparatus 2, devices that are the update targets (the first gateway 8 and in-vehicle ECUs 3), and the like. That is, FIG. 3 depicts the respective processing sequences of the external server S1, the in-vehicle apparatus 2, the first gateway 8, and an in-vehicle ECU 3 that is an update target when processing relating to a program update is performed at the in-vehicle apparatus 2 and devices that are the update targets (the first gateway 8 and the in-vehicle ECUs 3).

In the following description, for ease of explanation, an example will be described where the in-vehicle ECU 3Aa on the bus 4A, the first gateway 8, and the in-vehicle ECUs 3Ba and 3Bb on the bus 4B are the update targets.

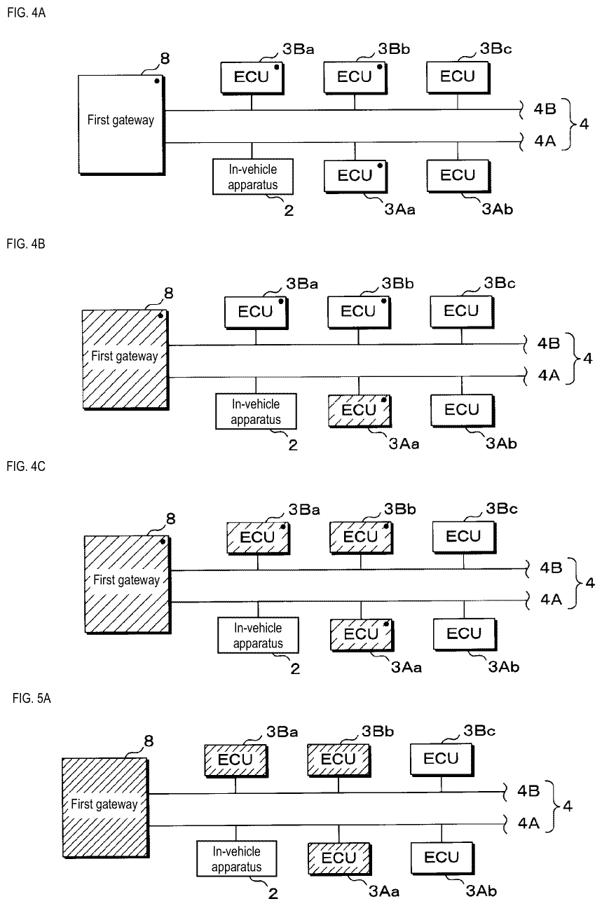

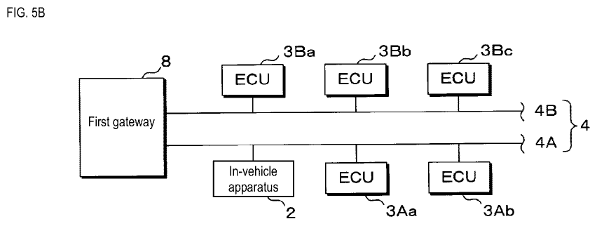

FIG. 4 is a diagram useful in explaining state transitions of the in-vehicle apparatus 2, the first gateway 8, and the in-vehicle ECUs 3 that are the update targets during a program updating process, and FIG. 5 is a diagram useful in explaining state transitions of the in-vehicle apparatus 2, the first gateway 8, and the in-vehicle ECUs 3 that are the update targets during a rollback process. FIG. 4 and FIG. 5 depict, for the first gateway 8 and the in-vehicle ECUs 3 that are the update targets, a state before application of an update program and a state after application by way of shading in the drawings. Note that in FIG. 4, devices to be updated are indicated by black circles.

The in-vehicle apparatus 2 acquires an update program from the external server S1 (S01). The in-vehicle apparatus 2 accesses the external server S1 using an identification number (or “Vehicle Identification Number” (VIN)) of the vehicle C (or “host vehicle”) in which the in-vehicle apparatus 2 is mounted, and acquires a package including the update program to be applied to the host vehicle from the external server S1. As one example, the package includes package information (or “campaign information”) which is information relating to a program update, information (or “target information”) relating to the first gateway 8 and the in-vehicle ECUs 3 that are the update targets, and an update program to be applied to the first gateway 8 and the in-vehicle ECUs 3 whose programs are the update targets.

The in-vehicle apparatus 2 stores the update program included in the acquired package in the storage unit 23 (S02). The acquired update program is stored in the first storage unit 231 or the second storage unit 232. The in-vehicle apparatus 2 also updates the update information based on the acquired package.

First, the in-vehicle apparatus 2 outputs (transmits) an update program for the first gateway 8 and the in-vehicle ECU 3Aa to the first gateway 8 and the in-vehicle ECU 3Aa (see FIG. 4A), which out of the update targets, are connected to the bus 4A to which the in-vehicle apparatus 2 is connected (hereinafter referred to as the “local bus 4A”) (S03). The in-vehicle apparatus 2 determines, based on the target information acquired from the external server S1, that the first gateway 8 is included in the update target and transmits the update program to the first gateway 8 and the in-vehicle ECU 3Aa on the local bus 4A.

The first gateway 8 stores the update program acquired (received) from the in-vehicle apparatus 2 in the storage unit 81, and the in-vehicle ECU 3Aa installs the update program acquired from the in-vehicle apparatus 2 in the storage unit (S04).

As one example, when a currently executed program is stored in the first area of the storage unit 81, the first area corresponds to the active side. In this case, an earlier version of the program than the currently executed program (or “old version”) is stored as a backup in the second area, which is the inactive side, of the storage unit 81. The first gateway 8 stores the acquired update program for the first gateway 8 in the second area, which is the inactive side. By doing so, it is possible to stably maintain the program that is currently being executed in its current operating state without such program being overwritten.

In the same way as the first gateway 8, the in-vehicle ECU 3Aa stores the acquired update program in the inactive side, which prevents the program that is currently being executed (and is stored in the active side) from being overwritten.

The in-vehicle apparatus 2 outputs (transmits) an activation instruction to the first gateway 8 and the in-vehicle ECU 3Aa on the local bus 4A (S05). The first gateway 8 and the in-vehicle ECU 3Aa perform an activation process in response to the activation instruction outputted from the in-vehicle apparatus 2 (S06). The first gateway 8 and the in-vehicle ECU 3Aa that have acquired (received) the activation instruction from the in-vehicle apparatus 2 perform an activation process that applies the update program by restarting with the storage area in which the update program is stored (that is, the inactive side in the state before restarting) set as the active side.

Through the processing described above, the activation process of the update program is completed at only the first gateway 8 and the in-vehicle ECU 3Aa out of the update targets (see FIG. 4B).

The in-vehicle apparatus 2 performs an operation check (or “abnormality detection”) process on the first gateway 8 and the in-vehicle ECU 3Aa for which the activation process has been completed (S07). As one example, the in-vehicle apparatus 2 requests the transmission of version information indicating the version of the program after updating and compares the version information sent from the first gateway 8 and the in-vehicle ECU 3Aa in response to the request from the in-vehicle apparatus 2 with the update information. When the versions match, the updating process is determined to be normal, but when the versions do not match, the updating process is determined to be abnormal.

In addition, as one example, the in-vehicle apparatus 2 may monitor the presence or absence of an autonomous transmission frame that is periodically transmitted from the first gateway 8 and the in-vehicle ECU 3Aa following the activation process and perform the abnormality detection process according to whether an autonomous transmission frame has been received.

In keeping with the result of abnormality detection, the in-vehicle apparatus 2 outputs (transmits) an update program for the in-vehicle ECUs 3 that are the update targets (the in-vehicle ECUs 3Ba and 3Bb) and are connected to the other bus 4B to which the in-vehicle apparatus 2 is not connected (hereinafter referred to simply as the “other bus 4B”) (S08). The in-vehicle apparatus 2 identifies the in-vehicle ECUs 3 that are the update targets on the other bus 4B based on the target information acquired from the external server S1, and transmits the update program for the in-vehicle ECUs 3 that have been identified via the first gateway 8 to the in-vehicle ECUs 3Ba and 3Bb on the bus 4B.

The in-vehicle ECUs 3 that are the update targets (here, the in-vehicle ECUs 3Ba and 3Bb) install the update program acquired (received) from the in-vehicle apparatus 2 via the first gateway 8 (S09). Like the first gateway 8, the in-vehicle ECUs 3Ba and 3Bb that are the update targets store the acquired update program in the inactive side, which prevents the program in the active side which is currently being executed from being overwritten.

The in-vehicle apparatus 2 outputs (transmits) an activation instruction via the first gateway 8 to the in-vehicle ECUs 3 (here, the in-vehicle ECUs 3Ba and 3Bb) that are the update targets on the other bus 4B (S10). The in-vehicle apparatus 2 outputs an activation instruction to each of the in-vehicle ECUs 3Ba and 3Bb to cause the in-vehicle ECUs 3Ba and 3Bb to execute the activation process.

The in-vehicle ECUs 3Ba and 3Bb on the other bus 4B perform the activation process in response to the activation instruction outputted from the in-vehicle apparatus 2 (S11). The in-vehicle ECUs 3Ba and 3Bb that have acquired (received) the activation instruction from the in-vehicle apparatus 2 perform the activation process that applies the update program by restarting with the storage area in which the update program is stored (that is, inactive side in the state before restarting) set as the active side.

Through the processing described above, the activation process of the update program is completed at all of the first gateway 8 and the in-vehicle ECUs 3Aa, 3Ba, and 3Bb, which are the update targets (see FIG. 4C and FIG. 5A).

The in-vehicle apparatus 2 performs an operation check (or “abnormality detection”) process on the in-vehicle ECUs 3Ba and 3Bb for which the activation process has been completed (S12). As one example, the in-vehicle apparatus 2 requests the transmission of version information indicating the version of the program after updating and compares the version information sent from the in-vehicle ECUs 3Ba and 3Bb via the first gateway 8 in response to the request from the in-vehicle apparatus 2 with the update information. When the versions match, the updating process is determined to be normal, but when the versions do not match, the updating process is determined to be abnormal.

In addition, as one example, the in-vehicle apparatus 2 may monitor the presence or absence of an autonomous transmission frame that is periodically transmitted from the in-vehicle ECUs 3Ba and ECU 3Bb following the activation process and perform the abnormality detection process according to whether the autonomous transmission frame has been received.

If the result of the abnormality detection is that the state is normal, the in-vehicle apparatus 2 outputs (transmits) a message that the updating process completed normally to the external server S1 and ends the updating process (see S16).

On the other hand, if an abnormality has been determined, the in-vehicle apparatus 2 simultaneously outputs (transmits) a rollback instruction to the first gateway 8 and the in-vehicle ECU 3Aa connected to the local bus 4A and the in-vehicle ECUs 3Ba and 3Bb connected to the other bus 4B (S13). In other words, if, for some reason, the updating of programs at the in-vehicle ECUs 3Ba and 3Bb has not completed normally, the in-vehicle apparatus 2 outputs (transmits) a rollback instruction to the first gateway 8 and the in-vehicle ECU 3Aa on the local bus 4A and to the in-vehicle ECUs 3Ba and 3Bb on the other bus 4B.

The first gateway 8 and the in-vehicle ECU 3Aa on the local bus 4A perform a rollback process in response to the rollback instruction outputted from the in-vehicle apparatus 2 (S14). The in-vehicle ECUs 3Ba and 3Bb on the other bus 4B perform a rollback process based on the rollback instruction outputted from the in-vehicle apparatus 2 (S15).

In more detail, the first gateway 8, the in-vehicle ECU 3Aa, and the in-vehicle ECUs 3Ba and 3Bb, which have received the rollback instruction outputted from the in-vehicle apparatus 2, perform the rollback process by restarting to execute the program (or “original program”) that was being executed before the update program was applied (that is, before the activation process). This original program is stored (saved) as a backup in a storage area (that is, the “inactive side”) that differs from the storage area (or “active side”) in which the update program is stored. The first gateway 8, the in-vehicle ECU 3Aa, and the in-vehicle ECUs 3Ba and 3Bb perform the rollback process by restarting with the storage area (or “inactive side”) in which the original program is stored set as the active side and the storage area in which the update program set is stored as the inactive side.

Through the processing described above, the rollback process is performed at all of the first gateway 8 and the in-vehicle ECU 3Aa, 3Ba, and 3Bb, which are the update targets, thereby restoring the execution environment of the original program (see FIG. 5B).

The in-vehicle apparatus 2 outputs (transmits) a result of the processing relating to the update program to the external server S1 (S16). As the result of the processing relating to the update program, the in-vehicle apparatus 2 outputs (transmits), to the external server S1, an update success notification, which indicates that the application of the update program to the first gateway 8 and the in-vehicle ECUs 3Aa, 3Ba, and 3Bb that are the update targets was successful, or an update failure notification, which indicates that the application of the update program failed and a rollback process was performed. The in-vehicle apparatus 2 may output the result of the processing relating to the update program to the display apparatus 5 and have the processing result displayed on the display apparatus 5. The in-vehicle apparatus 2 may modify the update information relating to the first gateway 8 and the in-vehicle ECUs 3Aa, 3Ba, and 3Bb that are the update targets based on the result of the processing relating to the update program.

The series of processes described above (S01 to S16) relating to a program update are performed during a period where starting of the vehicle C is prohibited, such as a period where starting of an engine or driving of a traction motor is prohibited. Performing the above processes during this prohibition period makes it possible to prevent an engine start or the like from being performed in a state where there is a temporary inconsistency (that is, a difference in versions) between the applied programs. When the in-vehicle apparatus 2 is performing a series of processes relating to a program update during a period where starting of the vehicle C is prohibited, the in-vehicle apparatus 2 may temporarily invalidate any on signal outputted from the ignition switch 6 via the input/output interface 21 and the like by performing a masking process or the like.

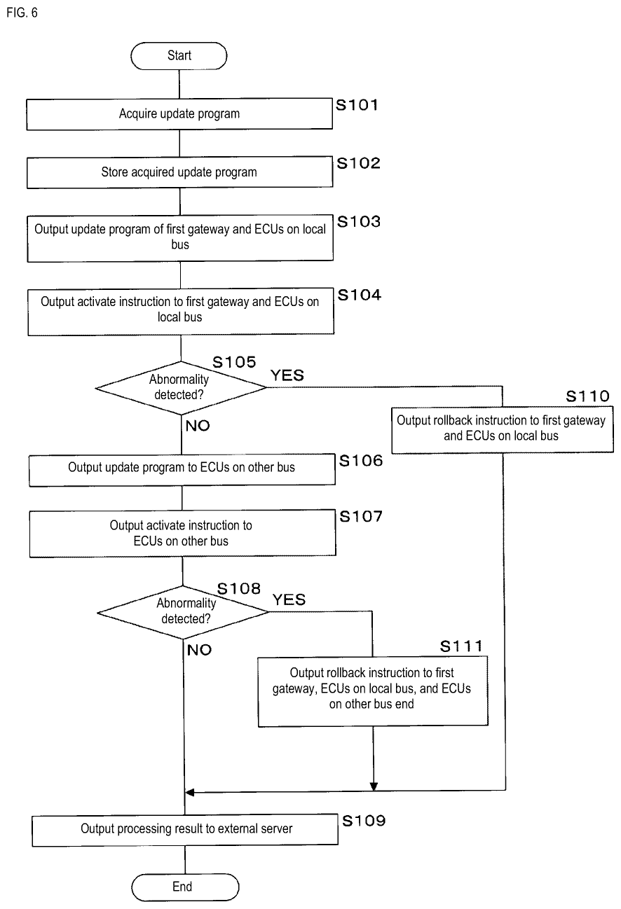

FIG. 6 is a flowchart illustrating one example of the processing of the control unit 20 of the in-vehicle apparatus 2. The control unit 20 of the in-vehicle apparatus 2 performs the following processing in a steady state, as one example, when the vehicle C is in a stopped state. In the following description, as depicted in FIG. 4 and FIG. 5, an example case will be described where the in-vehicle ECU 3Aa on the bus 4A, the first gateway 8, and the in-vehicle ECUs 3Ba and 3Bb on the bus 4B are the update targets.

The control unit 20 acquires an update program (or “package”) from the external server S1 via the external communication apparatus 1 (S101). The control unit 20 stores the update program included in the acquired package in the storage unit 23 (S102). The control unit 20 also updates the update information based on the acquired package.

First, the control unit 20 outputs (transmits) an update program to the first gateway 8 and the in-vehicle ECUs 3 on the local bus 4A that are the update targets (S103). The control unit 20 identifies the first gateway 8 and the in-vehicle ECUs 3 that are the update targets (here, the in-vehicle ECU 3Aa) based on the target information included in the package acquired from the external server S1, and transmits the update program to the first gateway 8 and the in-vehicle ECU 3Aa that have been identified.

At this time, the first gateway 8 stores the update program transmitted by the control unit 20 in the storage unit 81, and the in-vehicle ECU 3Aa installs the update program transmitted by the control unit 20 in the storage unit. Since the installation process for an update program like this has already been described, detailed description is omitted here.

Next, the control unit 20 outputs (transmits) an activation instruction to the first gateway 8 and the in-vehicle ECU 3Aa on the local bus 4A that are the update targets (S104). The control unit 20 outputs an activation instruction to each of the first gateway 8 and the in-vehicle ECU 3Aa to cause the first gateway 8 and the in-vehicle ECU 3Aa to execute the activation process.

At this time, the first gateway 8 and the in-vehicle ECU 3Aa perform the activation process in response to the activation instruction outputted from the in-vehicle apparatus 2. Since this activation process has already been described, detailed description is omitted here.

The control unit 20 performs an abnormality detection process (or “operation check”) on the first gateway 8 and the in-vehicle ECU 3Aa that have completed the activation process and determines whether an abnormality has been detected (S105). As one example, the control unit 20 requests transmission of version information indicating the version of the program after the updating and compares the version information sent from the first gateway 8 and the in-vehicle ECU 3Aa in response to this request from the control unit 20 with the update information in the storage unit 23. When the versions match, the control unit 20 determines that the state is normal (no abnormality) and determines that there is an abnormality when the versions do not match.

If an abnormality has been detected, that is, if it has been determined that there is an abnormality (S105: YES), the control unit 20 outputs (transmits) a rollback instruction to the first gateway 8 and the in-vehicle ECU 3Aa on the local bus 4A where the update program was installed (S110).

In response to this rollback instruction outputted from the in-vehicle apparatus 2, the first gateway 8 and the in-vehicle ECU 3Aa perform a rollback process. The first gateway 8 and the in-vehicle ECU 3Aa perform this rollback process by restarting so that the program (or “original program”) that was being executed before application of the update program (that is, the activation process) is executed. Since the rollback process has already been described, detailed description is omitted here.

After this, the processing advances to S109.

If no abnormality has been detected, that is, if the devices are determined to be normal (S105: NO), the control unit 20 outputs (transmits) the update program to the remaining in-vehicle ECUs 3 on the other bus 4B out of the update targets (S106). The control unit 20 identifies the in-vehicle ECUs 3 on the other bus 4B that are the update targets (here, the in-vehicle ECUs 3Ba and 3Bb) based on the target information included in the package acquired from the external server S1, and transmits the update program via the first gateway 8 to the identified in-vehicle ECUs 3Ba and 3Bb.

At this time, the in-vehicle ECUs 3Ba and 3Bb install the update program transmitted by the control unit 20 into their storage units. Since the installation process for an update program has already been described, detailed description is omitted here.

Next, the control unit 20 outputs (transmits) an activation instruction to the in-vehicle ECUs 3Ba and 3Bb on the other bus 4B that are the update targets (S107). The control unit 20 outputs an activation instruction via the first gateway 8 to each of the in-vehicle ECUs 3Ba and 3Bb to cause the in-vehicle ECUs 3Ba and 3Bb to execute the activation process.

At this time, the in-vehicle ECUs 3Ba and 3Bb perform the activation process in response to the activation instruction outputted from the in-vehicle apparatus 2. Since this activation process has already been described, detailed description is omitted here.

The control unit 20 performs an abnormality detection process (or “operation check”) on the in-vehicle ECUs 3Ba and 3Bb that have completed the activation process and determines whether an abnormality has been detected (S108). As one example, the control unit 20 requests transmission of version information indicating the version of the program after the updating and compares the version information sent from the in-vehicle ECUs 3Ba and 3Bb in response to this request from the control unit 20 with the update information in the storage unit 23. When the versions match, the control unit 20 determines that the state is normal (no abnormality) and determines that there is an abnormality when the versions do not match.

If an abnormality has been detected, i.e., if it has been determined that there is an abnormality (S108: YES), the control unit 20 outputs (transmits) a rollback instruction to the first gateway 8, the in-vehicle ECU 3Aa on the local bus 4A, and the in-vehicle ECUs 3Ba and 3Bb on the other bus 4B where the update program was installed (S111). Since it was confirmed in step S105 that the first gateway 8 is normal, a rollback instruction can be issued simultaneously to the first gateway 8, the in-vehicle ECU 3Aa on the local bus 4A, and the in-vehicle ECUs 3Ba and 3Bb on the other bus 4B.

In response to this rollback instruction outputted from the in-vehicle apparatus 2, the first gateway 8, the in-vehicle ECU 3Aa, and the in-vehicle ECUs 3Ba and 3Bb perform a rollback process. Since the rollback process has already been described, detailed description is omitted here.

Through the processing described above, the rollback process is performed at all of the first gateway 8 and in-vehicle ECUs 3Aa, 3Ba, and 3Bb that are the update targets, so that the execution environment of the original program is restored. Accordingly, inconsistencies are prevented from occurring due to differences in the program versions between the in-vehicle ECUs 3Ba and 3Bb and the first gateway 8 and in-vehicle ECU 3Aa.

On the other hand, if no abnormality has been detected, that is, if the state has been determined to be normal (S108: NO), the control unit 20 outputs (transmits) the result of the processing relating to the update program to the external server S1 (S109). The control unit 20 outputs (transmits), as the result of the processing relating to the update program, an update success notification indicating that the application of the update program to the first gateway 8 and the in-vehicle ECUs 3Aa, 3Ba, and 3Bb that are the update targets was successful or an update failure notification indicating that the application of the update program failed and a rollback process was performed, via the exterior communication apparatus 1 to the external server S1.

In the in-vehicle apparatus 2 according to the present embodiment, when updating a program, if the first gateway 8 is included in the update targets, the updating of the first gateway 8 is given priority. That is, as described above, when the update targets include the first gateway 8 and in-vehicle ECUs 3 on a local bus 4 and also in-vehicle ECUs 3 on another bus 4B, the in-vehicle apparatus 2 first completes the activation process for the first gateway 8 and the in-vehicle ECUs 3 on the local bus 4A, confirms that the first gateway 8 is normal, and then continues the process for the in-vehicle ECUs 3 on the other bus 4B. In this way, since the updating is executed after ensuring that the first gateway 8 is normal, the updating of programs at the in-vehicle ECUs 3 on the other bus 4B can be executed reliably. It is therefore possible to avoid a situation where communication between the local bus 4A and the other bus 4B is no longer possible after an updating process for a program.

Note that with the in-vehicle apparatus 2 according to the present embodiment, if the update targets include the first gateway 8 and in-vehicle ECUs 3 on the other bus 4B, that is, if in-vehicle ECUs 3 on the local bus 4A are not included, the in-vehicle apparatus 2 may first complete the activation process for the first gateway 8, confirm that the first gateway 8 is normal, and then continue the processing for the in-vehicle ECUs 3 on the other bus 4B.

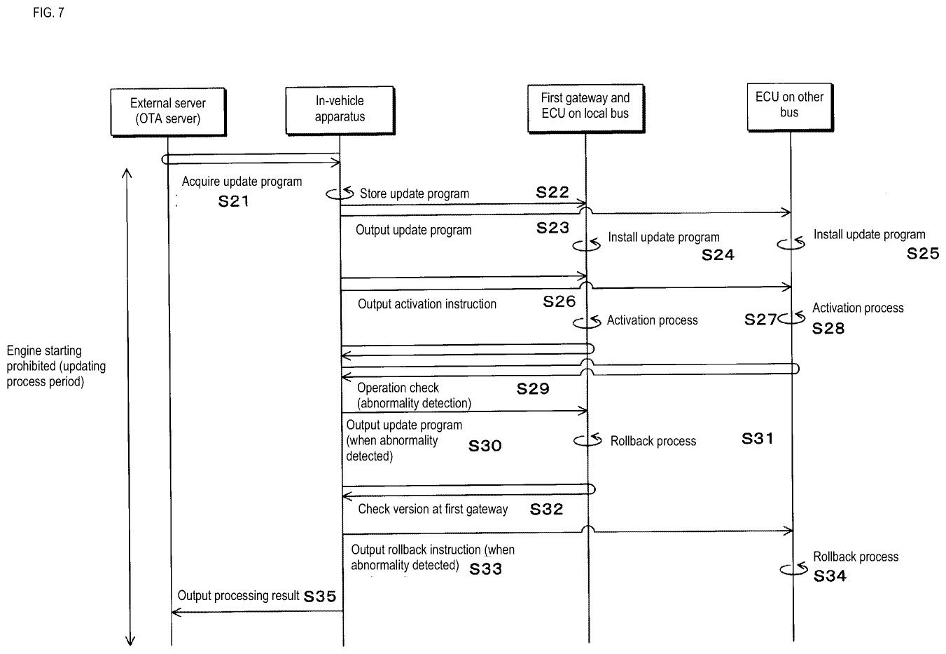

FIG. 7 is diagram useful in explaining another example of a processing flow (or “sequence”) of the in-vehicle apparatus 2, the devices that are the update targets (the first gateway 8 and in-vehicle ECUs 3), and the like.

For ease of explanation, the following describes an example where the in-vehicle ECU 3Aa on the bus 4A, the first gateway 8, and the in-vehicle ECUs 3Ba and 3Bb on the bus 4B are the update targets.

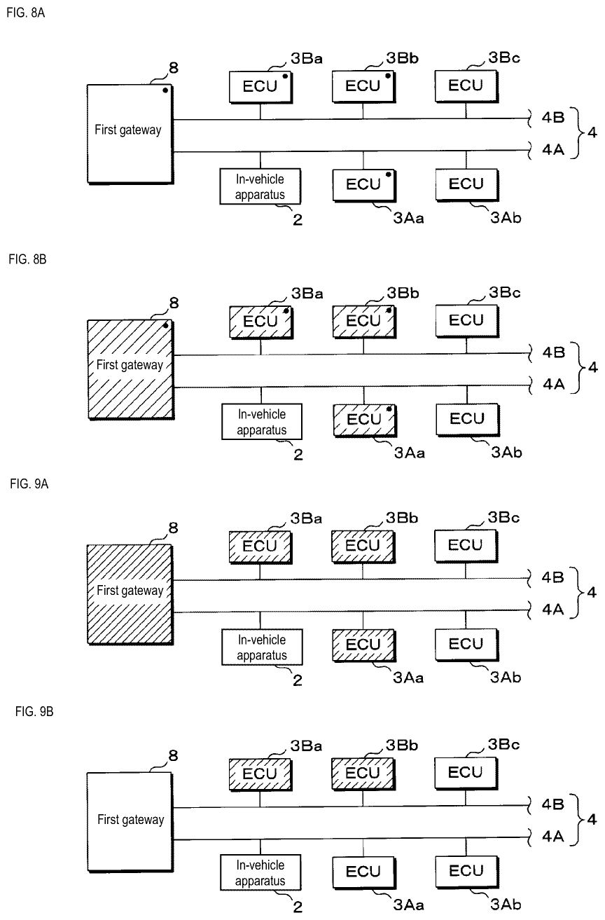

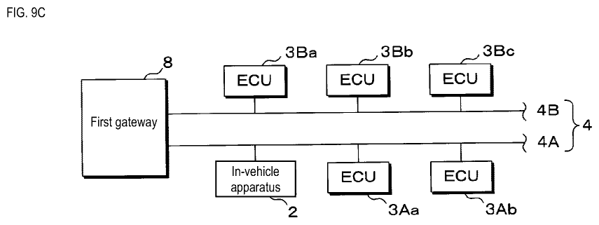

FIG. 8 is a diagram useful in explaining state transitions of the in-vehicle apparatus 2, the first gateway 8, and the in-vehicle ECUs 3 that are the update targets during a program updating process, and FIG. 9 is a diagram useful in explaining state transitions of the in-vehicle apparatus 2, the first gateway 8, and in-vehicle ECUs 3 that are the update targets during a rollback process. FIG. 8 and FIG. 9 depict, for the first gateway 8 and the in-vehicle ECUs 3, which are the update targets, states before and after application of an update program by way of shading in the drawings. Note that in FIG. 8, devices to be updated are indicated by black circles.

The in-vehicle apparatus 2 acquires an update program from the external server S1 (S21). As one example, the in-vehicle apparatus 2 accesses the external server S1 using an identification number (or “VIN”) of the vehicle C (or “host vehicle”) in which the in-vehicle apparatus 2 is mounted, and acquires a package including the update program to be applied to the host vehicle from the external server S1. As one example, the package includes package information (or “campaign information”) which is information relating to a program update, information (or “target information”) relating to the first gateway 8 and the in-vehicle ECUs 3 that are the update targets, and an update program to be applied to the first gateway 8 and the in-vehicle ECUs 3 whose programs are to be updated.

The in-vehicle apparatus 2 stores the update program included in the acquired package in the storage unit 23 (S22). The acquired update program is stored in the first storage unit 231 or the second storage unit 232. The in-vehicle apparatus 2 also updates the update information based on the acquired package.

Based on the target information acquired from the external server S1, the in-vehicle apparatus 2 outputs (transmits) an update program for the first gateway 8 and the in-vehicle ECUs to the first gateway 8 and the in-vehicle ECU 3Aa connected to the local bus 4A and the in-vehicle ECUs 3Ba and 3Bb (see FIG. 8A) connected to the other bus 4B, which are the update targets (S23).

The first gateway 8 stores the update program acquired (received) from the in-vehicle apparatus 2 in the storage unit 81, and the in-vehicle ECU 3Aa installs the update program acquired from the in-vehicle apparatus 2 in the storage unit (S24).

As one example, when a currently executed program is stored in the first area of the storage unit 81, the first area corresponds to the active side. In this case, an earlier version of the program than the currently executed program (or “old version”) is stored as a backup in the second area, which is the inactive side, of the storage unit 81. The first gateway 8 stores the acquired update program for itself in the second area, which is the inactive side. By doing so, it is possible to stably maintain the program that is currently being executed in its current operating state without such program being overwritten.

In the same way as the first gateway 8, the in-vehicle ECU 3Aa stores the acquired update program in the inactive side, which prevents the program that is currently being executed (and is stored in the active side) from being overwritten.

At this time, the in-vehicle ECU 3Ba and 3Bb that are the update targets install the update program acquired (received) via the first gateway 8 from the in-vehicle apparatus 2 (S25). By storing the acquired update program in the inactive side in the same way as the first gateway 8, the in-vehicle ECU 3Ba and 3Bb can prevent the program in the active side currently being executed from being overwritten.

The in-vehicle apparatus 2 outputs (transmits) an activation instruction to the first gateway 8 and the in-vehicle ECU 3Aa on the local bus 4A and the in-vehicle ECUs 3Ba and 3Bb (S26) on the other bus 4B and causes the first gateway 8 and the in-vehicle ECUs 3Aa, 3Ba, and 3Bb to execute the activation process.

The first gateway 8 and the in-vehicle ECU 3Aa on the local bus 4 perform the activation process in response to the activation instruction outputted from the in-vehicle apparatus 2 (S27). The first gateway 8 and the in-vehicle ECU 3Aa that have acquired (received) the activation instruction from the in-vehicle apparatus 2 perform the activation process that applies the update program by restarting with the storage area in which the update program is stored (that is, the inactive side in the state before restarting) set as the active side.

At this time, the in-vehicle ECUs 3Ba and 3Bb on the other bus 4B perform the activation process in response to the activation instruction outputted from the in-vehicle apparatus 2 (S28). The in-vehicle ECUs 3Ba and 3Bb that have acquired (received) the activation instruction from the in-vehicle apparatus 2 perform the activation process that applies the update program by restarting with the storage area in which the update program is stored (that is, the inactive side in the state before restarting) set as the active side.

Through the processing described above, the activation process of the update program is completed at all of the first gateway 8 and the in-vehicle ECUs 3Aa, 3Ba, and 3Bb, which are the update targets (see FIG. 8B and FIG. 9A).

The in-vehicle apparatus 2 performs an operation check (or “abnormality detection”) process on the first gateway 8 and the in-vehicle ECU 3Aa on the local bus 4A and the in-vehicle ECUs 3Ba and 3Bb on the other bus 4B for which the activation process has been completed (S29). Since the abnormality detection method has already been described, detailed description is omitted here.

If the result of the abnormality detection is that the state is normal, the in-vehicle apparatus 2 outputs (transmits) a message that the updating process completed normally to the external server S1 and ends the updating process (see S35).

On the other hand, if an abnormality has been determined, the in-vehicle apparatus 2 first outputs (transmits) a rollback instruction to the first gateway 8 and the in-vehicle ECU 3Aa connected to the local bus 4A (S30). In other words, if for some reason the program updating at the in-vehicle ECUs 3Ba and 3Bb did not complete normally or an abnormality occurred at the first gateway 8, the in-vehicle apparatus 2 first outputs (transmits) a rollback instruction to the first gateway 8 and the in-vehicle ECU 3Aa on the local bus 4A.

The first gateway 8 and the in-vehicle ECU 3Aa on the local bus 4A perform a rollback process in response to the rollback instruction outputted from the in-vehicle apparatus 2 (S31). The first gateway 8 and the in-vehicle ECU 3Aa that have received the rollback instruction outputted from the in-vehicle apparatus 2 perform the rollback process by restarting to execute the program (or “original program”) that was being executed before the update program was applied (that is, before the activation process). This original program is stored (saved) as a backup in a storage area (or “inactive side”) that differs from the storage area (or “active side”) in which the update program is stored. The first gateway 8 and the in-vehicle ECU 3Aa perform the rollback process by restarting with the storage area (or “inactive side”) in which the original program is stored set as the active side and the storage area in which the update program is stored set as the inactive side.

Through the processing described above, the rollback process is performed at only the first gateway 8 and the in-vehicle ECU 3Aa, thereby restoring the execution environment of the original program (see FIG. 9B). When doing so, the in-vehicle apparatus 2 updates the update information to information on the original program.

Next, the in-vehicle apparatus 2 checks whether the program version of the first gateway 8 after the rollback process is the original program version (S32). As one example, the in-vehicle apparatus 2 requests transmission of version information indicating the version of the program after the rollback process and compares the version information sent from the first gateway 8 in response to the request from the in-vehicle apparatus 2 with the update information.

If the program version of the first gateway 8 is the version of the original program, the in-vehicle apparatus 2 outputs (transmits) a rollback instruction to the in-vehicle ECUs 3Ba and 3Bb connected to the other bus 4B (S33). In other words, when the rollback process has been performed at the first gateway 8 and the in-vehicle ECU 3Aa out of the devices that are the update targets, the in-vehicle apparatus 2 also outputs a rollback instruction to the in-vehicle ECUs 3Ba and 3Bb, thereby preventing inconsistencies from occurring due to differences in program versions between the in-vehicle ECUs 3Ba and 3Bb and the first gateway 8 and in-vehicle ECU 3Aa.

The in-vehicle ECUs 3Ba and 3Bb on the other bus 4B perform the rollback process based on the rollback instruction outputted from the in-vehicle apparatus 2 (S34). The in-vehicle ECUs 3Ba and 3Bb that have received the rollback instruction outputted from the in-vehicle apparatus 2 perform the rollback process by restarting to execute the original program. This original program is stored (saved) in the inactive side as a backup. The in-vehicle ECUs 3Ba and 3Bb perform the rollback process by restarting with the inactive side in which the original program is stored set as the active side and the storage area in which the update program is stored switched to the inactive side.

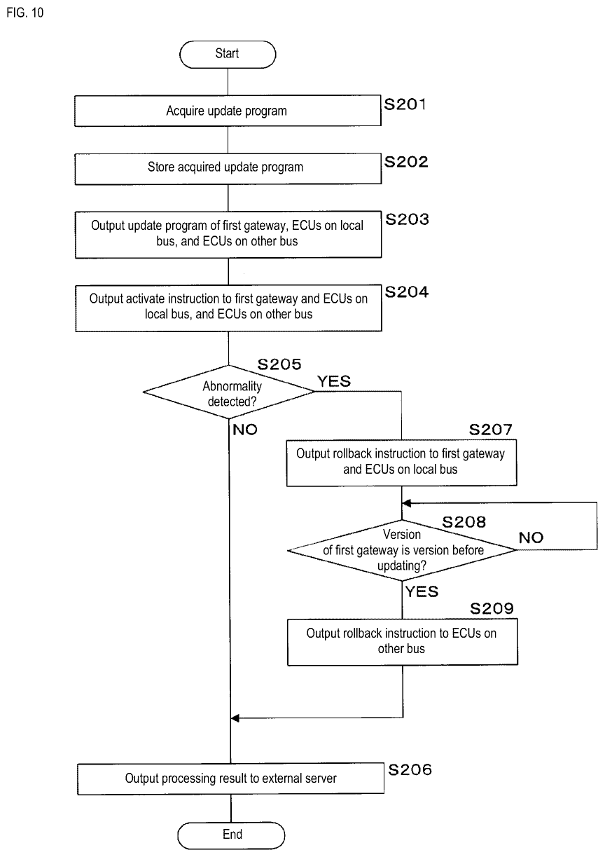

Through the processing described above, the rollback process is performed at all of the first gateway 8 and the in-vehicle ECUs 3Aa, 3Ba, and 3Bb that are the update targets, thereby restoring the execution environment of the original program (see FIG. 10C).

The in-vehicle apparatus 2 outputs (transmits) a result of the processing relating to the update program to the external server S1 (S35). As the result of the processing relating to the update program, the in-vehicle apparatus 2 outputs (transmits), to the external server S1, an update success notification, which indicates that the application of the update program to the first gateway 8 and the in-vehicle ECUs 3Aa, 3Ba, and 3Bb that are the update targets was successful, or an update failure notification, which indicates that the application of the update program failed and the rollback process was performed.

The series of processes described above (S21 to S35) relating to a program update are performed during a period where starting of the vehicle C is prohibited, such as a period where starting of an engine or driving of a traction motor is prohibited. Performing the above processes during this prohibition period makes it possible to prevent an engine start or the like from being performed in a state where there is a temporary inconsistency (that is, a difference in versions) between the applied programs.

FIG. 10 is a flowchart illustrating another example of the processing of the control unit 20 of the in-vehicle apparatus 2. The control unit 20 of the in-vehicle apparatus 2 performs the following processing in a steady state, as one example, when the vehicle C is stopped. In the following description, as depicted in FIG. 8 and FIG. 9, an example case will be described where the in-vehicle ECU 3Aa on the bus 4A, the first gateway 8, and the in-vehicle ECUs 3Ba and 3Bb on the bus 4B are the update targets.

The control unit 20 acquires an update program (or “package”) from the external server S1 via the external communication apparatus 1 (S201). The control unit 20 stores the update program included in the acquired package in the storage unit 23 (S202). The control unit 20 also updates the update information based on the acquired package.

The in-vehicle apparatus 2 outputs (transmits) an update program to the first gateway 8, the in-vehicle ECU 3Aa on the local bus 4A, and the in-vehicle ECUs 3Ba and 3Bb on the other bus 4B (S203). The control unit 20 identifies the first gateway 8 and the in-vehicle ECUs 3 that are the update targets (the in-vehicle ECUs 3Aa, 3Ba, and 3Bb) based on the target information included in the package acquired from the external server S1, and transmits the update program to the first gateway 8 and the in-vehicle ECUs 3Aa, 3Ba, and 3Bb that have been identified.

At this time, the first gateway 8 stores the update program transmitted by the control unit 20 in the storage unit 81, and the in-vehicle ECUs 3Aa, 3Ba, and 3Bb install the update program transmitted by the control unit 20 in the storage unit. Since the installation process of this update program has already been described, detailed description is omitted here.

Next, the control unit 20 outputs (transmits) an activation instruction to the first gateway 8, the in-vehicle ECU 3Aa on the local bus 4A, and the in-vehicle ECUs 3Ba and 3Bb on the other bus 4B which are the update targets (S204). The control unit 20 outputs an activation instruction to each of the first gateway 8 and the in-vehicle ECUs 3Aa, 3Ba, and 3Bb, and causes the first gateway 8 and the in-vehicle ECUs 3Aa, 3Ba, and 3Bb to execute the activation process.

At this time, the first gateway 8 and the in-vehicle ECUs 3Aa, 3Ba, and 3Bb perform the activation process in response to the activation instruction outputted from the in-vehicle apparatus 2. Since this activation process has already been described, detailed description is omitted here.

The control unit 20 performs an abnormality detection process (or “operation check”) for the first gateway 8 and the in-vehicle ECUs 3Aa, 3Ba, and 3Bb that have completed the activation process and determines whether an abnormality has been detected (S205). As one example, the control unit 20 requests transmission of version information indicating the version of the program after the updating, and compares the version information sent from the first gateway 8 and the in-vehicle ECUs 3Aa, 3Ba, and 3Bb in response to this request from the control unit 20 with the update information in the storage unit 23. If the versions match, the control unit 20 determines that the state is normal (with no abnormality), and if the versions do not match, the control unit 20 determines that there is an abnormality.

If an abnormality has been detected, that is, if it has been determined that there is an abnormality at the first gateway 8 or any of the in-vehicle ECUs Aa, 3Ba, and 3Bb (S205: YES), the control unit 20 first outputs (transmits) a rollback instruction to the first gateway 8 and the in-vehicle ECUs 3Aa on the local bus 4A (S207). When doing so, the control unit 20 updates the update information relating to the first gateway 8 and the in-vehicle ECU 3Aa on the local bus 4A to information of the original program.

In response to the rollback instruction outputted from the in-vehicle apparatus 2, the first gateway 8 and the in-vehicle ECU 3Aa perform the rollback process. The first gateway 8 and the in-vehicle ECU 3Aa perform the rollback process by restarting so as to execute the program (or “original program”) that was being executed before application of the update program (that is, before the activation process). Since the rollback process has already been described, detailed description is omitted here.

Next, the control unit 20 determines whether the version of the program at the first gateway 8 after the rollback process is the version of the original program before the update (S208). As one example, the control unit 20 requests transmission of version information indicating the version of the program after the rollback process and compares the version information sent from the first gateway 8 in response to this request from the control unit 20 with the update information.

On determining that the version of the program of the first gateway 8 after the rollback process is not the version of the original program before the update (S208: NO), the control unit 20 repeats this determination. The control unit 20 may be configured to return to S207 when this determination has been repeated a predetermined number of times or more.

If the control unit 20 has determined that the program version of the first gateway 8 after the rollback process is the version of the original program before the update (S208: YES), this confirms that the state of the first gateway 8 is normal, so that the control unit 20 outputs (transmits) a rollback instruction to the in-vehicle ECUs 3Ba and 3Bb on the other bus 4B (S209). At this time, the control unit 20 updates the update information relating to the in-vehicle ECUs 3Ba and 3Bb on the other bus 4B to information on the original program.

The in-vehicle ECUs 3Ba and 3Bb perform the rollback process in response to the rollback instruction outputted from the in-vehicle apparatus 2. Since the rollback process has already been described, detailed description is omitted here.

Through the processing described above, the rollback process is performed at all of the first gateway 8 and the in-vehicle ECUs 3Aa, 3Ba, and 3Bb that are the update targets, so that the execution environment of the original program is restored.

On the other hand, if no abnormality has been detected in S205, that is, if the state has been determined to be normal (S205: NO), the control unit 20 outputs (transmits) the result of the processing relating to the update program to the external server S1 (S206). The control unit 20 outputs (transmits), as the result of the processing relating to the update program, an update success notification indicating that application of the update program to the first gateway 8 and the in-vehicle ECUs 3Aa, 3Ba, and 3Bb that are the update targets was successful, or an update failure notification indicating that the application of the update program failed and that a rollback process has been performed, via the external communication apparatus 1 to the external server S1.

As described above, with the in-vehicle apparatus 2 according to the present embodiment, if an abnormality has occurred at an in-vehicle ECU 3 on the other bus 4B or at the first gateway 8 after a program update, a rollback process for the first gateway 8 is given priority. In other words, if an abnormality has occurred at an in-vehicle ECU 3 on the other bus 4 or the first gateway 8 after activation processes for all of the devices that are the update targets (that is, the first gateway 8 and the in-vehicle ECUs 3Aa, 3Ba, and 3Bb) have been completed, the in-vehicle apparatus 2 first has a rollback process executed at the first gateway 8 and the in-vehicle ECUs 3 on the local bus 4A. By doing so, after it has been ensured that the first gateway 8 is in a normal state in an execution environment of the original program, the in-vehicle apparatus 2 has a rollback process executed at the in-vehicle ECUs 3 on the other bus 4B. In this way, since execution is performed after ensuring that the first gateway 8 is in a normal state, the rollback process can be executed correctly at the in-vehicle ECUs 3 on the other bus 4B. This makes it possible to prevent communication failures between the local bus 4A and the other bus 4B due to an abnormality occurring after an updating process for a program.

### First Modification

Although the above description refers to an example configuration where only in-vehicle ECUs 3 are connected to the other bus 4B, the present disclosure is not limited to this.

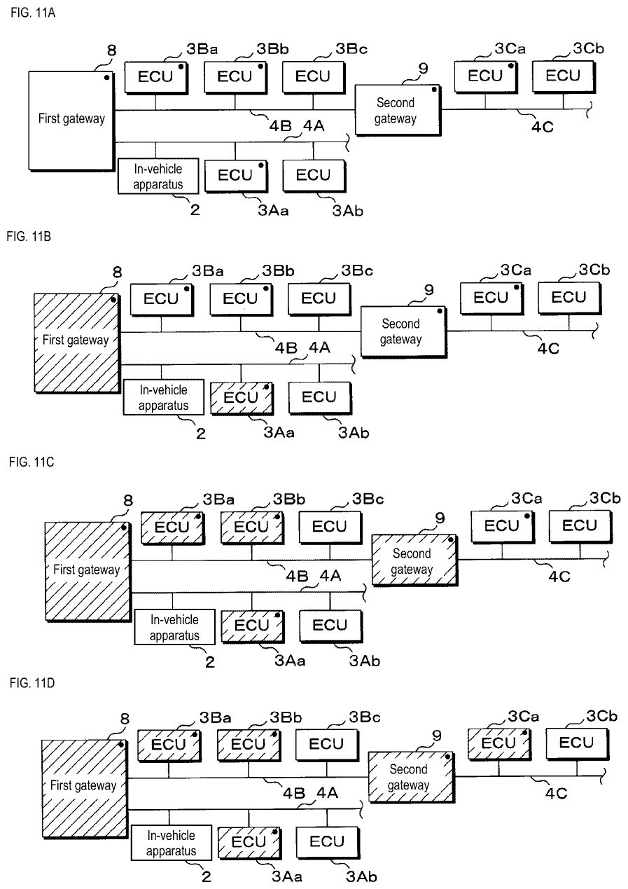

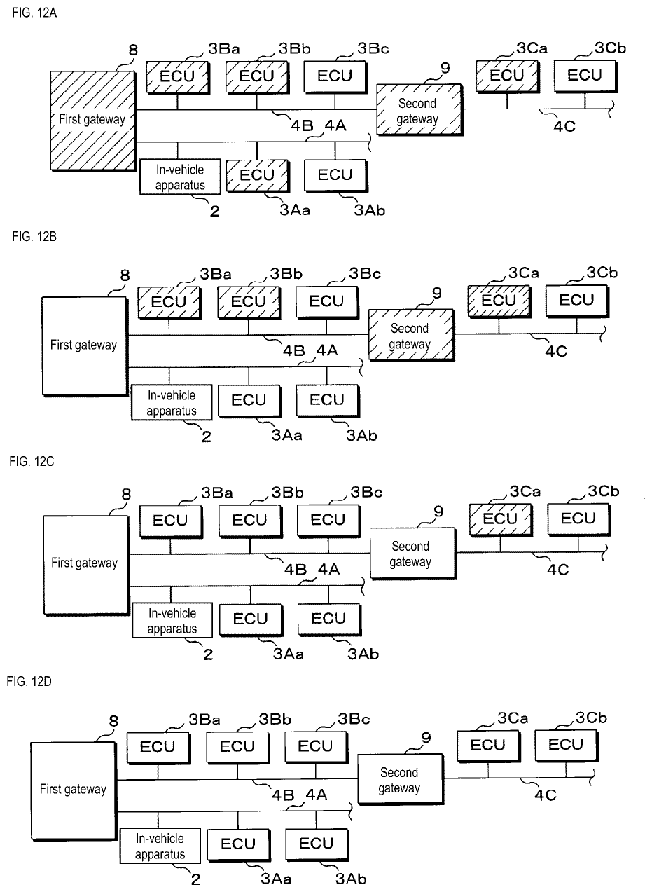

FIG. 11 is a diagram useful in explaining state transitions at each apparatus during an updating process for a program according to a first modification, and FIG. 12 is a diagram useful in explaining state transitions at each apparatus during a rollback process according to this first modification. FIGS. 11 and 12 depict, for the first gateway 8 and the in-vehicle ECUs 3 that are the apparatuses corresponding to the update targets, the states before and after application of an update program by way of shading in the drawings. Note that in FIG. 11, the devices to be updated are indicated by black circles.

In this modification, the local bus 4A and the other bus 4B are connected to the first gateway 8, a second gateway 9 is further connected to the other end of the other bus 4B, and a bus 4C is connected to the second gateway 9. The in-vehicle apparatus 2 and the in-vehicle ECUs 3Aa and 3Ab are connected to the local bus 4A, the in-vehicle ECUs 3Ba, 3Bb, and 3Bc are connected to the other bus 4B, and in-vehicle ECUs 3Ca and 3Cb are connected to the bus 4C.

In the in-vehicle apparatus 2 according to this modification, when programs are to be updated and the update targets include the first gateway 8 and other apparatuses, the updating of the first gateway 8 is given priority. For ease of explanation, an example where the update targets are the in-vehicle ECU 3Aa on the local bus 4A, the first gateway 8, the in-vehicle ECUs 3Ba and 3Bb on the bus 4B, the second gateway 9, and the in-vehicle 3Ca is described below (see FIG. 11A).

First, the in-vehicle apparatus 2 performs the activation process for the first gateway 8 and the in-vehicle ECUs 3 (here, the in-vehicle ECU 3Aa) on the local bus 4A (see FIG. 11B). After the activation process for the first gateway 8 and the in-vehicle ECU 3Aa has been completed, the in-vehicle apparatus 2 checks whether the first gateway 8 is operating normally (abnormality detection). When the first gateway 8 is operating normally, the in-vehicle apparatus 2 performs processing as far as the activation process at the in-vehicle ECUs 3 (the in-vehicle ECUs 3Ba and 3Bb) on the other bus 4B and the second gateway 9 via the first gateway 8 (see FIG. 11C). After the activation process at the second gateway 9 and the in-vehicle ECUs 3Ba and 3Bb has completed, the in-vehicle apparatus 2 checks whether the second gateway 9 is operating normally (that is, abnormality detection). If the second gateway 9 is operating normally, the in-vehicle apparatus 2 continues the activation process for the in-vehicle ECUs 3 (that is, the in-vehicle ECU 3Ca) on the bus 4C via the first gateway 8 and the second gateway 9 (see FIG. 11D).

In this way, when the first gateway 8 and the second gateway 9 are included in the update targets, the in-vehicle apparatus 2 gives priority to updating the first gateway 8, which has a smaller number of hops, and then updates the second gateway 9, so that the updating of programs is executed after ensuring that the first gateway 8 and the second gateway 9 are in a normal state. This makes it possible to correctly update programs at the in-vehicle ECUs 3 on the other bus 4B and the in-vehicle ECUs 3 on the bus 4C.

If an abnormality has occurred at the first gateway 8, an in-vehicle ECU 3 on the other bus 4B the second gateway 9, or an in-vehicle ECU 3 on the bus 4C after a program update, the in-vehicle apparatus 2 according to this modification performs the rollback process at the first gateway 8 with priority.

It is also conceivable that after the activation process has been completed at all of the devices to be updated (that is, the first gateway 8, the second gateway 9, and the in-vehicle ECUs 3Aa, 3Ba, 3Bb, and 3Ca) (see FIG. 12A), an abnormality may occur at any of the first gateway 8, the second gateway 9, or the in-vehicle ECUs 3Aa, 3Ba, 3Bb, and 3Ca.

In this case, the in-vehicle apparatus 2 first has the rollback process executed at the first gateway 8 and in-vehicle ECUs 3 (here, the in-vehicle ECU 3Aa) on the local bus 4A (see FIG. 12B). By doing so, it is ensured that the first gateway 8 is in a normal state for the execution environment of the original program. After this, the in-vehicle apparatus 2 has the rollback process executed at the in-vehicle ECUs 3 (here, the in-vehicle ECUs 3Ba and 3Bb) on the other bus 4B and the second gateway 9 via the first gateway 8 (see FIG. 12C). By doing so, it is ensured that the second gateway 9 is in a normal state for the execution environment of the original program. After this, the in-vehicle apparatus 2 has the in-vehicle ECUs 3 (here, the in-vehicle ECU 3Ca) on the bus 4C execute the rollback process via the first gateway 8 and the second gateway 9 (see FIG. 12D).

In this way, when the first gateway 8 and the second gateway 9 are included in the target of a rollback process, the in-vehicle apparatus 2 performs the rollback process at the first gateway 8, which has a smaller number of hops, with priority and then the rollback process at the second gateway 9, and thereby ensures that the first gateway 8 and the second gateway 9 are in the normal state before executing the rollback process. This means that the rollback process can be correctly executed for the in-vehicle ECUs 3 on the other bus 4B and the in-vehicle ECUs 3 on the bus 4C.

### Second Modification

The present disclosure can also be used when the in-vehicle updating system S includes a virtual network. As one example, a virtualized operating system, such as hypervisor, VMware, or Xen, is stored in a storage unit (not illustrated) of the vehicle C (see FIG. 1). By starting up using a virtualized operating system, the control unit (not illustrated) of the vehicle C can construct a plurality of virtual apparatuses on the virtualized operating system. By executing a specific program on each virtual apparatus, one or a plurality of tasks are generated according to the processing content of the program.

Although an example where the virtualization method is a hypervisor-type method where a virtualized operating system directly accesses hardware resources, such as a control unit, has been described in the present embodiment, the virtualization method is not limited to a hypervisor-type method. As one example, the virtualization method may be a host OS method where an operating system, such as Linux (registered trademark), is interposed between the virtualized operating system and the hardware resources. The virtualization method may also use a container-type virtualized operating system.

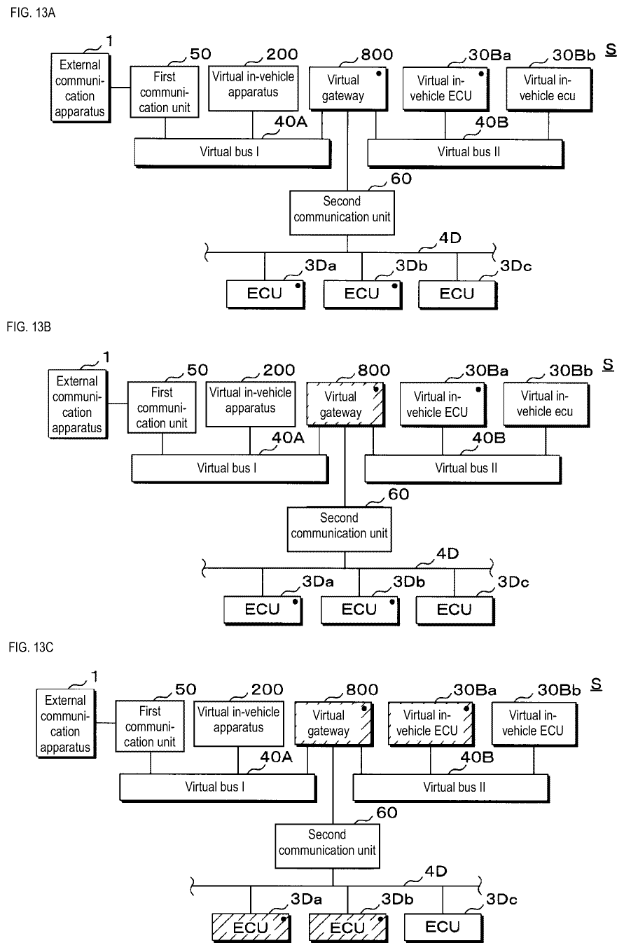

FIG. 13 is a diagram illustrating a configuration in which the in-vehicle updating system S according to the second modification includes a virtual network.

The vehicle C that has started up using a virtualized operating system can construct a virtual in-vehicle apparatus 200, a virtual gateway 800, a virtual in-vehicle ECU 30Ba, a virtual in-vehicle ECU 30Bb, a virtual bus I 40A, and a virtual bus II 40B using the functions of the virtualized operating system. The virtual in-vehicle apparatus 200 and the virtual gateway 800 are logically connected to the virtual bus I 40A, and the virtual gateway 800, the virtual in-vehicle ECU 30Ba, and the virtual in-vehicle ECU 30Bb are logically connected to the virtual bus II 40B. The virtual bus I 40A is also connected to the external communication apparatus 1 via the first communication unit 50, and the virtual gateway 800 is connected to the bus 4D via the second communication unit 60. In-vehicle ECUs 3Da, 3Db, and 3Dc are connected to the bus 4D.

As one example, the virtual in-vehicle apparatus 200, the virtual gateway 800, and the virtual in-vehicle ECUs 30Ba and 30Bb are assigned hardware resources of the control unit of the vehicle C, and the virtual bus I 40A and the virtual bus II 40B are assigned hardware resources of the storage unit of the vehicle C.

In the in-vehicle updating system S according to this second modification, when programs are updated and the virtual gateway 800 is included in the update targets, updating of the virtual gateway 800 is performed with priority. For ease of explanation, an example where the virtual in-vehicle ECU 30Ba on the virtual bus II 40B, the virtual gateway 800, and the in-vehicle ECUs 3Da and 3 Db on the bus 4D are the update targets is described below (see FIG. 13A).

First, the virtual in-vehicle apparatus 200 performs processing up to the activation process at the virtual gateway 800 (see FIG. 13B). After the activation process at the virtual gateway 800 has been completed, the virtual in-vehicle apparatus 200 checks whether the virtual gateway 800 is operating normally (abnormality detection). If the virtual gateway 800 is operating normally, the virtual in-vehicle apparatus 200 performs processing up to the activation process on the virtual in-vehicle ECU 30Ba on the virtual bus II 40B via the virtual gateway 800 and performs processing up to the activation process on the in-vehicle ECUs 3Da and 3Db on the bus 4D via the second communication unit 60 (see FIG. 13C).

With the in-vehicle updating system S according to the second modification, if an abnormality occurs at the virtual gateway 800, the virtual in-vehicle ECU 30Ba, or the in-vehicle ECUs 3Da and 3Db after a program update, the rollback process of the virtual gateway 800 is performed with priority. In other words, the rollback process is performed at the virtual gateway 800 first, and then the rollback process is performed at the virtual in-vehicle ECU 30Ba or the in-vehicle ECUs 3Da and 3Db. Since the rollback process has already been described, detailed description is omitted here.

The embodiments disclosed above are exemplary in all respects and should not be regarded as limitations on the present disclosure. The scope of the present disclosure is indicated by the range of the patent claims, not the description given above, and is intended to include all changes within the meaning and scope of the patent claims and their equivalents.

1. An in-vehicle apparatus that is connected to a first bus connected to a relay apparatus that relays communication between buses, acquires an update program from outside a vehicle, and updates a program of the relay apparatus and an in-vehicle ECU,
the in-vehicle apparatus comprising a control unit configured to update the relay apparatus with priority, when update targets include the relay apparatus and an in-vehicle ECU on a second bus connected to the relay apparatus.

2. The in-vehicle apparatus according to claim 1,
wherein when the update targets include the relay apparatus, the in-vehicle ECU on the second bus, and the in-vehicle ECU on the first bus, the control unit updates the relay apparatus and the in-vehicle ECU on the first bus with priority.

3. The in-vehicle apparatus according to claim 2,
further comprising an abnormality detection unit configured to detect an abnormality at the relay apparatus after an activation process, which applies the update program to the relay apparatus, has been executed.

4. The in-vehicle apparatus according to claim 3,
wherein when an abnormality has not been detected, the control unit updates the in-vehicle ECU on the second bus.

5. The in-vehicle apparatus according to claim 2,
wherein when the update targets further include another relay apparatus, which is connected to the second bus, and an in-vehicle ECU on a third bus connected to the other relay apparatus,
the control unit updates the in-vehicle ECU on the second bus and the other relay apparatus together and,
performs an updating process for the in-vehicle ECU on the third bus after updating the other relay apparatus.

6. The in-vehicle apparatus according to claim 3,
wherein when an abnormality has been detected, the control unit executes a rollback process, which restores a program after updating to a program before updating, at the relay apparatus and the in-vehicle ECU on the first bus with priority.

7. The in-vehicle apparatus according to claim 6,
wherein the control unit executes the rollback process at the in-vehicle ECU on the second bus after executing the rollback process on the relay apparatus.

8. The in-vehicle apparatus according to claim 7,
wherein when updating has also been performed at another relay apparatus connected to a second bus and an in-vehicle ECU on a third bus connected to the other relay apparatus,
the control unit performs a rollback process at the ECU on the second bus and the other relay apparatus together, and performs a rollback process on the in-vehicle ECU on the third bus after the rollback process on the other relay apparatus.

9. A computer program that causes an in-vehicle computer, which is connected to a first bus connected to a relay apparatus that relays communication between buses, acquires an update program from outside a vehicle, and updates a program of the relay apparatus and an in-vehicle ECU, to execute a process comprising
updating the relay apparatus with priority, when update targets include the relay apparatus and an in-vehicle ECU on a second bus connected to the relay apparatus.

10. A program updating method that causes an in-vehicle apparatus, which is connected to a first bus connected to a relay apparatus that relays communication between buses, acquires an update program from outside a vehicle, and updates a program of the relay apparatus and an in-vehicle ECU, to execute a process comprising
updating the relay apparatus with priority, when update targets include the relay apparatus and an in-vehicle ECU on a second bus connected to the relay apparatus.

11. The in-vehicle apparatus according to claim 3,
wherein when the update targets further include another relay apparatus, which is connected to the second bus, and an in-vehicle ECU on a third bus connected to the other relay apparatus,
the control unit updates the in-vehicle ECU on the second bus and the other relay apparatus together and,
performs an updating process for the in-vehicle ECU on the third bus after updating the other relay apparatus.

12. The in-vehicle apparatus according to claim 4,
wherein when the update targets further include another relay apparatus, which is connected to the second bus, and an in-vehicle ECU on a third bus connected to the other relay apparatus,
the control unit updates the in-vehicle ECU on the second bus and the other relay apparatus together and,
performs an updating process for the in-vehicle ECU on the third bus after updating the other relay apparatus.
